(19) United States
(12) Patent Application Publication
(10) Pub. No.: US 2025/0135584 A1
(43) Pub. Date: May 1, 2025

(54) GROOVE FORMING APPARATUS

(71) Applicant: EO TECHNICS CO.,LTD., Gyeonggi-do (KR)

(72) Inventors: Woong Hee JOUNG, Gyeonggi-do (KR); Jung Rae PARK, Gyeonggi-do (KR); Byung Oh KIM, Seoul (KR); Dong Jun LEE, Seoul (KR); Jun Young LEE, Gyeonggi-do (KR); Geun Haeng LEE, Gyeonggi-do (KR); Chan Hee KANG, Incheon (KR)

(73) Assignee: EO TECHNICS CO.,LTD., Gyeonggi-do (KR)

(21) Appl. No.: 18/692,319

(22) PCT Filed: Sep. 14, 2022
(86) PCT No.: PCT/KR2022/013743

§ 371 Date: Mar. 14, 2024

(30) Foreign Application Priority Data
Sep. 15, 2021 (KR) 10-2021-0123419
Feb. 8, 2022 (KR) 10-2022-0016426

(51) Int. Cl. B23K 26/364; B23K 26/064; G02B 13/22; G02B 27/42

(52) U.S. Cl. CPC B23K 26/364; B23K 26/064; G02B 13/22; G02B 27/4233

(57) ABSTRACT

A groove forming apparatus includes a laser light source configured to emit a laser beam, a multi-beam generator configured to split the laser beam into a plurality of sub-laser beams, a focusing lens unit configured to focus the plurality of sub-laser beams on a processing object, a first telecentric lens provided between the multi-beam generator and the focusing lens unit, and a second telecentric lens provided between the first telecentric lens and the focusing lens unit.

### TECHNICAL FIELD

The present disclosure relates to a groove forming apparatus.

### BACKGROUND ART

In general, laser processing refers to a method whereby processing is performed by focusing a laser beam into a single focal point by using a condensing lens and projecting the focal point onto the surface or inside of a processing object.

In order to form a groove, a method of processing a processing object while sequentially moving multi-beams along one processing path may be used. When a spacing between multi-beams is narrow, a heat affected zone (HAZ) may occur in a processing object around a groove, a bottom surface of the groove may be processed unevenly or excessively (bottom over-processing) and sidewalls of the groove may be inclined excessively.

### DISCLOSURE

### Technical Problem

A problem to be solved is to provide a groove forming apparatus capable of using sub-laser beams split at a maximum angle in a multi-beam generator in a groove forming process. Accordingly, a groove forming apparatus capable of performing a groove forming process with high efficiency and speed is provided.

A problem to be solved is to provide a groove forming apparatus for forming a groove having a required shape (for example, a shape in which no heat affected zone (HAZ) occurs, a bottom surface of the groove is uniform, and a lowermost width of the groove is 75% or more of an uppermost width of the groove).

However, the problems to be solved are not limited to those described above.

### Technical Solution

In an aspect, there may be provided a groove forming apparatus including: a laser light source configured to emit a laser beam; a multi-beam generator configured to split the laser beam into a plurality of sub-laser beams; a focusing lens unit configured to focus the plurality of sub-laser beams on a processing object; a first telecentric lens provided between the multi-beam generator and the focusing lens unit; and a second telecentric lens provided between the first telecentric lens and the focusing lens unit.

A rear focal plane of the first telecentric lens and a front focal plane of the second telecentric lens may overlap each other.

The first telecentric lens may have a size to receive the plurality of sub-laser beams split at a maximum angle from the multi-beam generator.

The maximum angle may be ±3°.

The multi-beam generator may be configured to split the plurality of sub-laser beams so that a spacing between the plurality of sub-laser beams on the processing object is 50 μm or more.

Spacings between the plurality of sub-laser beams on the processing object may be equal to each other.

At least two of spacings between the plurality of sub-laser beams on the processing object may be different from each other.

The plurality of sub-laser beams may be symmetrically arranged on the processing object.

The plurality of sub-laser beams may have same intensity.

At least two of the plurality of sub-laser beams may have different intensities.

The groove forming apparatus may further include a scan head, wherein the focusing lens unit may be arranged inside the scan head, and the multi-beam generator, the first telecentric lens, and the second telecentric lens may be arranged outside the scan head.

The groove forming apparatus may further include a stage supporting the processing object, wherein the stage may be configured to adjust a position at which the plurality of sub-laser beams are focused on the processing object.

In an aspect, there may be provided a groove forming apparatus including: a laser light source configured to emit a laser beam; a multi-beam generator configured to split the laser beam into a plurality of sub-laser beams; and a focusing lens unit configured to focus the plurality of sub-laser beams on a processing object, wherein the focusing lens unit is apart from the multi-beam generator so as to receive the plurality of sub-laser beams split at a maximum angle from the multi-beam generator.

The maximum angle may be ±3°.

The multi-beam generator may be configured to split the plurality of sub-laser beams so that a spacing between the plurality of sub-laser beams on the processing object is 50 μm or more.

### Advantageous Effects

The present disclosure may provide a groove forming apparatus capable of using sub-laser beams split at a maximum angle in a multi-beam generator in a groove forming process. Accordingly, the groove forming process may be performed with high efficiency and speed.

The present disclosure may provide a groove forming apparatus for forming a groove having a required shape (for example, a shape in which an occurrence of a heat affected zone (HAZ) is minimized, a bottom surface of the groove is processed non-excessively and evenly, and lowermost width of the groove is 75% or more of an uppermost width of the groove).

However, the effects of the present disclosure are not limited to those described above.

### DESCRIPTION OF DRAWINGS

FIG. 1 is a conceptual diagram of a groove forming apparatus according to an exemplary embodiment.

FIG. 2 is a conceptual diagram of a focusing lens unit of FIG. 1.

FIG. 3 is a conceptual diagram of a groove forming apparatus according to an exemplary embodiment.

FIG. 4 is a plan view of a processing object for illustrating sub-laser beams irradiated to a processing object, according to an exemplary embodiment.

FIG. 5 is a plan view of a processing object for illustrating sub-laser beams irradiated to a processing object, according to an exemplary embodiment.

FIG. 6 is a diagram illustrating a groove processed with five sub-laser beams having a beam spacing of 45 μm.

FIG. 7 is a diagram illustrating a groove processed with eight sub-laser beams having a beam spacing of 25 μm.

FIG. 8 is a diagram illustrating a groove processed with five sub-laser beams having a beam spacing of 150 μm.

FIG. 9 is a diagram illustrating a groove processed with eight sub-laser beams having a beam spacing of 200 μm.

FIG. 10 is a graph showing relative intensities of sub-laser beams according to an exemplary embodiment.

FIG. 11 is a graph showing relative intensities of sub-laser beams according to an exemplary embodiment.

FIGS. 12 and 13 are conceptual diagrams for illustrating a positional relationship between a processing object and a focusing lens unit, according to an exemplary embodiment.

### MODE FOR INVENTION

Hereinafter, embodiments of the present disclosure will be described in detail with reference to the accompanying drawings. In the drawings, the same reference numerals denote the same elements and the size or thickness of each element may be exaggerated for clarity of explanation.

It will be understood that although the terms including ordinal numbers, such as “first” or “second,” may be used herein to describe various elements, these elements should not be limited by these terms. These terms are only used to distinguish one element from another. For example, while not departing from the scope of the present disclosure, a first element may be referred to as a second element, and similarly, a second element may be referred to as a first element. The term “and/or” includes a combination of a plurality of related recited items or any one of a plurality of related recited items.

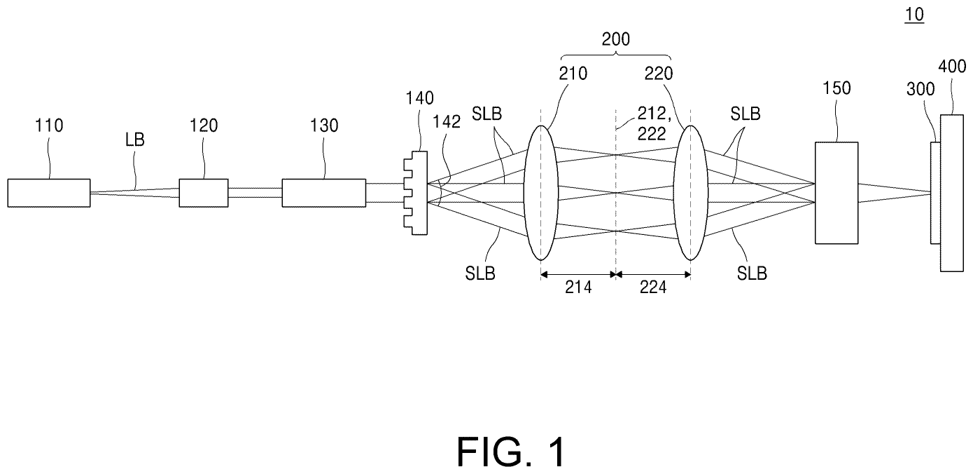

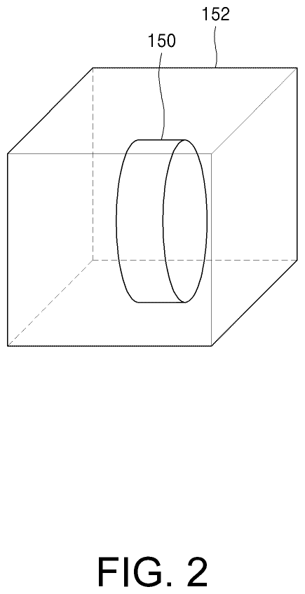

FIG. 1 is a conceptual diagram of a groove forming apparatus according to an exemplary embodiment. FIG. 2 is a conceptual diagram of a focusing lens unit of FIG. 1.

Referring to FIG. 1, a groove forming apparatus 10 including a laser light source 110, a collimator 120, a beam expander 130, a multi-beam generator 140, a telecentric lens unit 200, a focusing lens unit 150, and a stage 400 may be provided. The laser light source 110 may emit a laser beam LB. For example, the laser beam LB may be a pulsed laser. The laser light source 110 may provide the laser beam LB to the collimator 120. The laser beam LB emitted from the laser light source 110 may be divergent light. For example, the laser beam LB may have a width that widens in a traveling direction until before reaching the collimator 120.

The collimator 120 may convert the laser beam LB into parallel light. The laser beam LB may have a substantially constant width after passing through the collimator 120. A width of the laser beam LB may be a size of the laser beam LB in a direction substantially perpendicular to the traveling of the laser beam LB. The collimator 120 may include a single lens or a combination of a plurality of lenses. The collimator 120 may provide the laser beam LB, which is parallel light, to the beam expander 130.

The beam expander 130 may expand the width of the laser beam LB. The beam expander 130 may be an optical system including a plurality of lenses. The beam expander 130 may provide the laser beam LB with an expanded width to the multi-beam generator 140.

The multi-beam generator 140 may split the laser beam LB into sub-laser beams SLB. Three sub-laser beams SLB are illustrated, but this is only an example. In another example, three or more sub-laser beams SLB may be provided. For example, the multi-beam generator 140 may include at least one of a diffractive optical element (DOE), a cube-type beam splitter, and a prism-type beam splitter. For brevity of explanation, hereinafter, the multi-beam generator 140 is described as including the DOE. The sub-laser beams SLB may be obtained by diffracting the laser beam LB by the multi-beam generator 140. In an example, the sub-laser beams SLB may have symmetry. For example, the sub-laser beam SLB located in the center may be a 0th order diffraction beam. The sub-laser beams SLB arranged in a direction away from the sub-laser beam SLB located in the center may be ±1^{st} order diffraction beams, ±2^{nd} order diffraction beams, . . . , and ±n^{th} order diffraction beams. + and − may indicate directions away from the central sub-laser beam SLB. For example, the +1^{st} order, +2^{nd} order, . . . , and +n^{th} order diffraction beams may be sequentially arranged on one side of the central sub-laser beam SLB, and the −1^{st} order, −2^{nd} order, . . . , and −n^{th} order diffraction beams may be sequentially arranged on the other side of the central sub-laser beam SLB. In an example, all the sub-laser beams SLB emitted from the multi-beam generator 140 may be used in the groove forming process. In another example, low-order diffraction beams among the sub-laser beams SLB emitted from the multi-beam generator 140 may be used in the groove forming process. The use of the low-order diffraction beams in the groove forming process is described below.

A maximum value of a splitting angle 142 (hereinafter, a maximum angle) at which the sub-laser beams SLB used in the groove forming process are split by the multi-beam generator 140 may be about ±3°. The maximum angle may be an angle between a chief ray of the 0th order diffraction beam and chief rays of beams having the highest order. For example, when the highest order is ±3, the angles between the chief rays of the ±3^{rd} order diffraction beams and the chief ray of the 0^{th} order diffraction beam may each be ±3°. The angle between the sub-laser beams SLB adjacent to each other may be determined as necessary. Conditions for patterns formed in the DOE (e.g., the distance between patterns, the arrangement form of patterns, the size of patterns, etc.) may be determined so that the sub-laser beams SLB are split at a required angle. Each of the sub-laser beams SLB may be parallel light having a constant width. The multi-beam generator 140 may provide the sub-laser beams SLB to the telecentric lens unit 200.

The telecentric lens unit 200 may transmit the sub-laser beams SLB to the focusing lens unit 150. The telecentric lens unit 200 may serve as a relay lens that increases the length of the optical system. The telecentric lens unit 200 may include a first telecentric lens 210 and a second telecentric lens 220 arranged in a direction away from the multi-beam generator 140 along the optical path of the sub-laser beams SLB.

The first telecentric lens 210 may have an infinite focal length toward the multi-beam generator 140 and may have a first focal length 214 toward the second telecentric lens 220. In other words, a front focal length of the first telecentric lens 210 may be infinite and a rear focal length of the first telecentric lens 210 may be the first focal length 214. A first focal plane 212 may be located at a position spaced apart from the center of the first telecentric lens 210 by the first focal length 214 toward the second telecentric lens 220. The first telecentric lens 210 may focus the sub-laser beams SLB on the first focal plane 212. In an example, the chief rays of the sub-laser beams SLB that pass through the first telecentric lens 210 may be substantially parallel to each other.

The second telecentric lens 220 may have a second focal length 224 toward the first telecentric lens 210 and may have an infinite focal length toward the focusing lens unit 150 to be described below. In other words, a front focal length of the second telecentric lens 220 may be the second focal length 224 and a rear focal length of the second telecentric lens 220 may be infinite. A second focal plane 222 may be located at a position spaced apart from the center of the second telecentric lens 220 by the second focal length 224 toward the first telecentric lens 210. The second focal plane 222 may substantially overlap the first focal plane 212. The sub-laser beams SLB focused on the first focal plane 212 (i.e., the second focal plane 222) by the first telecentric lens 210 may diverge after passing through the first focal plane 212. In other words, the width of the sub-laser beams SLB may decrease as the sub-laser beams SLB pass through the first telecentric lens 210 and approaches the first focal plane 212, and may increase as the sub-laser beams SLB pass through the first focal plane 212 and approaches the second telecentric lens 220. The sub-laser beams SLB may be converted into parallel light having a constant width by the second telecentric lens 220. The second telecentric lens 220 may provide the sub-laser beams SLB to the focusing lens unit 150.

In an example, the first telecentric lens 210 and the second telecentric lens 220 may be substantially identical to each other. For example, the first focal length 214 and the second focal length 224 may be substantially identical to each other. In an example, the first telecentric lens 210 and the second telecentric lens 220 may be different from each other. For example, the first focal length 214 may be different from the second focal length 224. The first telecentric lens 210 and the second telecentric lens 220 may include a single lens or a composite lens.

In an example, low-order diffraction beams (e.g., 0^{th} order diffraction beam, ±1^{st} order diffraction beams, ±2^{nd} order diffraction beams, or ±3^{rd} order diffraction beams) may be selectively used in the groove forming process. In other words, high-order diffraction beams (e.g., fourth or higher order diffraction beams) may not be used in the groove forming process. In an example, in order to prevent the sub-laser beams SLB corresponding to undesired high-order diffraction beams from being used in the groove forming process, the groove forming apparatus 10 may further include at least one of a first mask (not shown) and a second mask (not shown) that block high-order diffraction beams.

The first mask may be provided on the optical path between the multi-beam generator 140 and the first telecentric lens 210. The first mask may block high-order diffraction beams, which are not used in the groove forming process among the sub-laser beams SLB formed by the multi-beam generator 140, from being provided to the first telecentric lens 210. For example, the first mask may be an aperture stop.

The second mask may be provided on the optical path between the first telecentric lens 210 and the second telecentric lens 220. For example, the second mask may be located on the first rear focal plane (or the second front focal plane). The second mask may block high-order diffraction beams, which are not used in the groove forming process among the sub-laser beams passing through the first telecentric lens 210, from being provided to the second telecentric lens 220. For example, the second mask may be a spatial filter.

When the first mask and the second mask are provided simultaneously, more than 99% of high-order diffraction beams that are not used in the groove forming process may be blocked.

The focusing lens unit 150 may focus the sub-laser beams SLB on the processing object 300. The focusing lens unit 150 may include a single lens or a composite lens. For example, the focusing lens unit 150 may include an f50 telecentric lens having a focal length of 50 mm. As illustrated in FIG. 2, the focusing lens unit 150 may be arranged within a scan head 152. The scan head 152 may include elements other than the focusing lens unit 150. For example, the scan head 152 may further include mirrors that transmits the sub-laser beams SLB provided from the telecentric lens unit 200 to the focusing lens unit 150, and/or a galvanic scanner that adjusts the position on the processing object 300 onto which the sub-laser beams SLB are irradiated. A spacing between the sub-laser beams SLB on the processing object 300 may be referred to as a beam spacing. The beam spacing may be 50 μm or more. For example, the beam spacing may be 50 μm to 1,000 μm.

The stage 400 may face the focusing lens unit 150. The stage 400 may support the processing object 300 and may adjust the position of the processing object 300. The stage 400 may move the processing object 300 in a horizontal direction and a vertical direction. For example, the horizontal direction may be a direction parallel to a top surface of the stage 400 and the vertical direction may be a direction perpendicular to the top surface of the stage 400. While the stage 400 moves the processing object 300, the sub-laser beams SLB may be irradiated to the processing object 300 so that the groove forming process is performed.

When necessary, optical elements (e.g., mirrors) that change the optical path may be arranged between the optical elements described above.

When the sub-laser beams SLB split at the maximum angle by the multi-beam generator 140 are used in the groove forming process, an efficiency and speed of the groove forming process may be high. For example, the sub-laser beams SLB may be split at a maximum angle (e.g., +3°) and the spacing between a pair of sub-laser beams SLB located on an outermost side on the processing object 300 may be up to 4,000 μm, and when the beam spacing is required to be 500 μm or more, up to nine sub-laser beams SLB may be used in the groove forming process. At this time, when an optical element that receives the sub-laser beams SLB emitted from the multi-beam generator 140 does not receive all of the sub-laser beams SLB emitted from the multi-beam generator 140, fewer than the nine sub-laser beams SLB may be used in the groove forming process. In this case, the efficiency and speed of the groove forming process may be low.

The groove forming apparatus 10 of the present disclosure uses the sub-laser beams SLB split at the maximum angle by the multi-beam generator 140 in the groove forming process, thereby increasing the efficiency and speed of the groove forming process. In addition, the present disclosure may increase the degree of freedom in configuring the optical system by using the first telecentric lens 210 and the second telecentric lens 220.

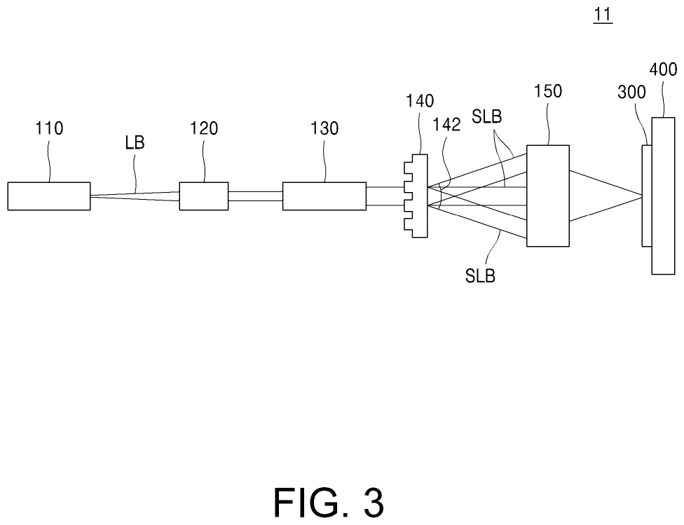

FIG. 3 is a conceptual diagram of a groove forming apparatus according to an exemplary embodiment. For brevity of explanation, differences from those described with reference to FIGS. 1 and 2 are described.

Referring to FIG. 3, a groove forming apparatus 11 may be provided. Unlike the focusing lens unit 150 of the groove forming apparatus 10 described with reference to FIGS. 1 and 2, a focusing lens unit 150 of the groove forming apparatus 11 may be arranged immediately adjacent to a multi-beam generator 140. Sub-laser beams SLB may be emitted from the multi-beam generator 140 and directly provided to the focusing lens unit 150. The telecentric lens unit 200 is not provided. A maximum splitting angle of the sub-laser beams SLB that may be received by the focusing lens unit 150 may vary depending on the separation distance between the focusing lens unit 150 and the multi-beam generator 140. As the focusing lens unit 150 is farther away from the multi-beam generator 140, the maximum splitting angle of the sub-laser beams SLB that may be received by the focusing lens unit 150 may decrease. The focusing lens unit 150 may be arranged adjacent to the multi-beam generator 140 so as to receive all of the sub-laser beams SLB split at the maximum angle (e.g., +3°) by the multi-beam generator 140. For example, when the focusing lens unit 150 includes an f50 telecentric lens having a focal length of 50 mm and an entrance pupil diameter (EPD) of 24 mm, the separation distance between the focusing lens unit 150 and the multi-beam generator 140 may be 10 mm or less.

The groove forming apparatus 11 of the present disclosure uses the sub-laser beams SLB split at the maximum angle by the multi-beam generator 140 in the groove forming process, thereby increasing the efficiency and speed of the groove forming process.

Hereinafter, a groove forming method using sub-laser beams SLB is described.

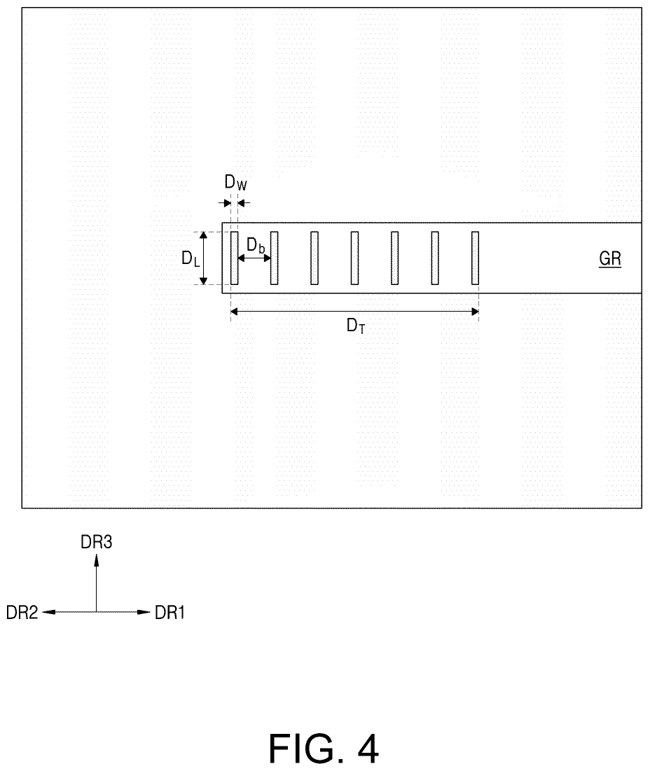

FIG. 4 is a plan view of a processing object for illustrating sub-laser beams irradiated to the processing object, according to an exemplary embodiment.

Referring to FIG. 4, seven sub-laser beams SLB may be irradiated to a processing object 300. In an example, the stage 400 may move the processing object 300 while the sub-laser beams SLB are irradiated to the processing object 300. For example, the stage 400 may move the processing object 300 in the first direction DR1. Accordingly, a groove GR may be formed in the processing object 300. As described above, the number of sub-laser beams SLB may be determined as necessary. The seven sub-laser beams SLB may be 0^{th} order, ±1^{st} order, ±2^{nd} order, and ±3^{rd} order diffraction beams. For example, the central sub-laser beam SLB is the 0th order diffraction beam, sub-laser beams SLB corresponding to the +1^{st} order diffraction beam, the +2^{nd} order diffraction beam, and the +3^{rd} order diffraction beam may be sequentially arranged along the first direction DR1 from the central sub-laser beam SLB, and sub-laser beams SLB corresponding to the −1^{st} order diffraction beam, the −2^{nd} order diffraction beam, and the −3^{rd} order diffraction beam may be sequentially arranged along the second direction DR2 opposite to the first direction DR1 from the central sub-laser beam SLB. In an example, a distance DT between a pair of sub-laser beams SLB (i.e., the +3^{rd} order diffraction beams) located at the outermost side among the sub-laser beams SLB may be 100 μm to 4,000 μm. Each of the sub-laser beams SLB may extend in the third direction DR3 crossing the first direction DR1 and the second direction DR2. For example, a length D_{L} of the sub-laser beams SLB along the third direction DR3 may be 30 μm to 200 μm. A width D_{W} of the sub-laser beams SLB may be 5 μm to 20 μm. The width D_{W} of the sub-laser beams SLB may be the size of the sub-laser beams SLB along the first direction DR1 or the second direction DR2.

The sub-laser beams SLB may be arranged at substantially the same spacing Db. Hereinafter, the spacing between the sub-laser beams SLB may be referred to as the beam spacing Db. When the beam spacing Db is less than 50 μm, the groove GR may not have a required shape. For example, due to an accumulation of latent heat generated by the sub-laser beams SLB, a heat affected zone (HAZ) in which the processing object 300 around may be excessively generated, and accordingly, a bottom surface of the groove GR may be processed uneven or over-processed, or a lowest width of the groove GR may become 75% or less of an uppermost width of the groove GR, resulting in a low taper ratio (steepness). In addition, as the sub-laser beams SLB process the processing object 300 at an excessively short spacing, dust generated may accumulate around the upper portion of the groove GR. In other words, the processability of the groove (GR) processing may be lowered.

The groove forming apparatuses 10 and 11 of the present disclosure may form the groove GR with the sub-laser beams SLB having a beam spacing Db of 50 μm or more. For example, the beam spacing Db may be 50 μm to 1,000 μm. Because the beam spacing Db between the sub-laser beams SLB is wide, the accumulation of latent heat by the sub-laser beams SLB may be reduced, and an occurrence of the HAZ may be minimized, unlike a case where the beam spacing Db is less than 50 μm. Accordingly, the bottom surface of the groove GR may be uniformly processed without excessive processing, and the lowermost width of the groove GR becomes 75% or more of the uppermost width of the groove GR, thereby increasing the taper ratio. That is, the groove forming apparatuses 10 and 11 of the present disclosure may form the groove GR having a required shape.

When the processing object includes a plurality of materials having different reactivity to heat, with sub-laser beams SLB having a beam spacing that enables processing of a required quality for one material, processing of required quality for other material may not be performed. That is, as the other material is processed, the HAZ may excessively occur, sidewalls of the groove GR may have a low taper ratio, and the bottom portion of the groove GR may be processed unevenly and excessively. Because the groove forming apparatus 10 of the present disclosure performs processing with the sub laser beams SLB having a beam spacing Db of 50 μm or more, the processing may be performed with the quality required for the plurality of materials having different reactivity to heat. In other words, the groove forming apparatus 10 of the present disclosure may have homogeneous processability for a plurality of different materials.

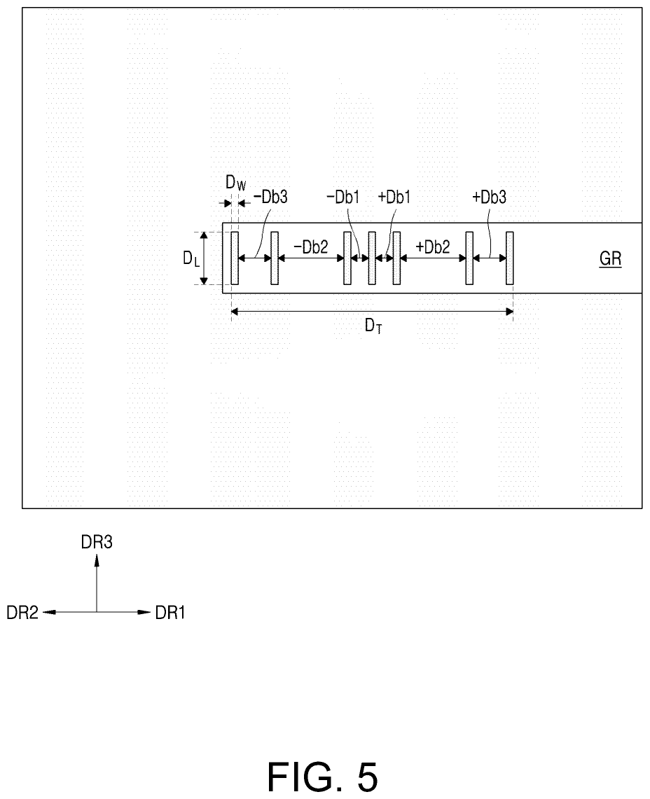

FIG. 5 is a plan view of a processing object for illustrating sub-laser beams irradiated to the processing object, according to an exemplary embodiment. For brevity of explanation, substantially the same content as that described with reference to FIG. 4 may not be described.

Referring to FIG. 5, seven sub-laser beams SLB may be provided. The sub-laser beams SLB may be substantially the same as the sub-laser beam SLB described with reference to FIG. 4, except for beam spacings.

Unlike those described with reference to FIG. 4, the sub-laser beams SLB may be arranged at different spacings. Beam spacings between the sub-laser beams SLB are referred to as +1 beam spacing +Db1, +2 beam spacing +Db2, +3 beam spacing +Db3, −1 beam spacing −Db1, −2 beam spacing −Db2, and −3 beam spacing −Db3, respectively. The sub-laser beams SLB corresponding to +1^{st} order, +2^{nd} order, and +3^{rd} order diffraction beams may be symmetrically arranged around the central sub-laser beam SLB corresponding to the 0^{th} order diffraction beam. The +1 beam spacing +Db1, the +2 beam spacing +Db2, and the +3 beam spacing +Db3 may be substantially equal to the −1 beam spacing-Db1, the −2 beam spacing −Db2, and the −3 beam spacing −Db3, respectively. At least two of the +1 beam spacing +Db1, the +2 beam spacing +Db2, and the +3 beam spacing +Db3 (or the −1 beam spacing-Db1, the −2 beam spacing −Db2, and the −3 beam spacing −Db3) may be different. Each of the +1 beam spacing +Db1, the +2 beam spacing +Db2, the +3 beam spacing +Db3, the −1 beam spacing-Db1, the −2 beam spacing −Db2, and the −3 beam spacing −Db3 may be 50 μm or more. For example, each of the +1 beam spacing +Db1, the +2 beam spacing +Db2, the +3 beam spacing +Db3, the −1 beam spacing −Db1, the −2 beam spacing −Db2, and the −3 beam spacing −Db3 may be 50 μm to 1,000 μm. The +1 beam spacing +Db1, the +2 beam spacing +Db2, and the +3 beam spacing +Db3 (or the −1 beam spacing −Db1, the −2 beam spacing −Db2, and the −3 beam spacing −Db3) may be determined as necessary.

Because the groove forming apparatuses 10 and 11 of the present disclosure form the groove GR with the sub-laser beams SLB having the +1 beam spacing +Db1, the +2 beam spacing +Db2, the +3 beam spacing +Db3, the −1 beam spacing −Db1, the −2 beam spacing −Db2, and the −3 beam spacing −Db3, which are each 50 μm or more, latent heat by the sub-laser beam SLB that has performed first processing may be sufficiently reduced when a subsequent next sub-laser beam SLB performs processing. Accordingly, the groove forming apparatuses 10 and 11 of the present disclosure may form the groove GR having a required shape (e.g., a shape in which HAZ generation is minimized, the bottom surface is uniformly processed without excessive, and the lowermost width of the groove GR is 75% or more of the uppermost width of the groove GR).

In an example, the groove GR may be formed so as to cut the processing object. A side surface of the groove GR is more ideal as it is closer to vertical, and as a difference between an upper width of the groove GR and a lower width of the groove GR increases, the side surface of the groove GR has a gentle inclination. After the groove formation (grooving processing) using the laser, the processing object is cut with a blade along the groove GR, and as a slope of the side surface of the groove GR is gentler, it is highly likely that the rotating blade will contact the sidewall of the groove while being inserted to the lower portion of the groove, thus causing a crack. Accordingly, the groove GR may be processed so that the lower width of the groove GR is 75% or more of the upper width of the groove GR. Alternatively, considering a depth of the groove GR, the groove GR may be processed so that the average of the slopes of both sidewalls of the groove GR is 2 or more. The average of the slopes of both sidewalls may be ‘depth of groove/(upper width of groove−lower width of groove)/2’.

A cutting process of the processing object by using the groove GR formed by the groove forming apparatuses 10 and 11 of the present disclosure was performed. The blade used in the this experiment had a width of 30 μm, and considering processing tolerance±5 μm of the blade, the lower width of the groove GR was set to be 40 μm and the upper width of the groove GR was set to be 52 μm or less. Energy of each beam used in the experiment was 5 W.

In the processing of a non-metallic patterned wafer, when the beam spacing (Db, +Db1, +Db2, +Db3, −Db1, −Db2, −Db3) is 50 μm or more, the difference between the upper width of the groove GR and the lower width of the groove GR is 12 μm or less, and when the beam spacing (Db, +Db1, +Db2, +Db3, −Db1, −Db2, −Db3) is 40 μm or more, the average of the slopes of both sidewalls is 2 or more.

In addition, in the processing of a metallic patterned wafer, when the beam spacing (Db, +Db1, +Db2, +Db3, −Db1, −Db2, −Db3) is 40 μm or more, the difference between the upper width of the groove GR and the lower width of the groove GR is 12 μm or less, and when the beam spacing (Db, +Db1, +Db2, +Db3, −Db1, −Db2, −Db3) is 20 μm or more, the average of the slopes of both sidewalls is 2 or more.

That is, when the beam spacing (Db, +Db1, +Db2, +Db3, −Db1, −Db2, −Db3) is 50 μm or more, the ratio of the lower width of the groove Gr to the upper width of the groove GR and the average of the slopes of both sidewalls may be satisfied in both the processing of the non-metallic patterned wafer and the processing of the metallic patterned wafer.

On the other hand, the HAZ reduces the strength of the processing object, and at the same time, as an amount of the HAZ increases and an height of the HAZ increases, the difference between the upper width of the groove GR and the lower width of the groove GR increases. Therefore, it is preferable that the height of the HAZ decreases. As a result of the experiment, it was confirmed that as the beam spacing (Db, +Db1, +Db2, +Db3, −Db1, −Db2, −Db3) increases, the height of the HAZ decreases. In other words, as the beam spacing (Db, +Db1, +Db2, +Db3, −Db1, −Db2, −Db3) increases, it may be advantageous in preventing the occurrence of the HAZ. However, when the beam spacing (Db, +Db1, +Db2, +Db3, −Db1, −Db2, −Db3) was narrower than 40 μm, the width of the HAZ rapidly increased. In addition, even in the metallic patterned wafer, the height of the HAZ decreased when the beam spacing (Db, +Db1, +Db2, +Db3, −Db1, −Db2, −Db3) was greater than 40 μm, but in the non-metallic patterned wafer, the height of the HAZ decreased rapidly when the beam spacing (Db, +Db1, +Db2, +Db3, −Db1, −Db2, −Db3) was greater than 40 μm. Therefore, when the beam spacing (Db, +Db1, +Db2, +Db3, −Db1, −Db2, −Db3) is 40 μm or more, advantageous processing results may be obtained in terms of the height and width of the HAZ for both the non-metallic patterned wafer and the metallic patterned wafer.

Summarizing the above experimental results, in conclusion, when the beam spacing (Db, +Db1, +Db2, +Db3, −Db1, −Db2, −Db3) is 50 μm or more, satisfactory processing results may be obtained in terms of the taper ratio, the slope, and the height and width of the HAZ, regardless of the material of the processing object 300.

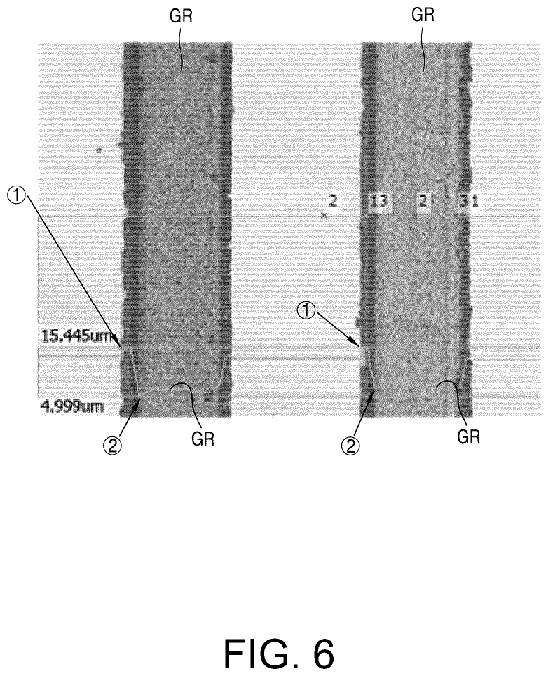

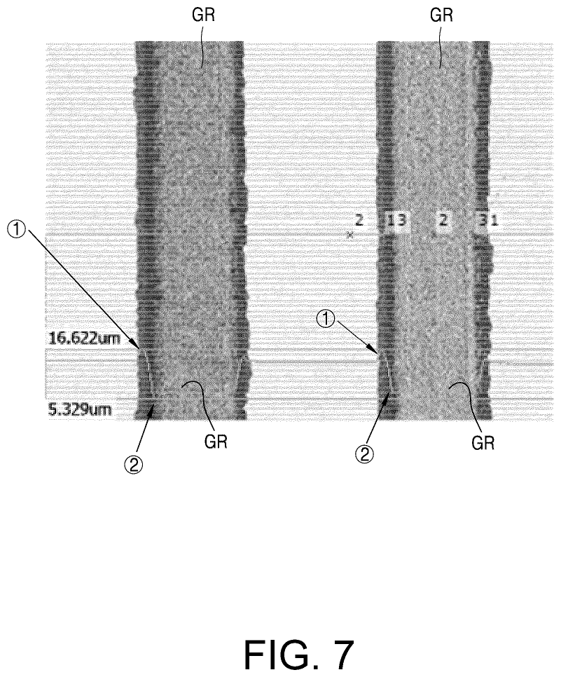

FIG. 6 is a diagram illustrating a groove processed with five sub-laser beams having a beam spacing of 45 μm. FIG. 7 is a diagram illustrating a groove processed with eight sub-laser beams having a beam spacing of 25 μm.

Referring to FIGS. 6 and 7, a planar photograph of the groove GR and a cross-sectional shape graph of the groove GR are illustrated in an overlapping manner. The groove GR had a large HAZ (\textcircled{1}) and an over-processed lower area (\textcircled{2}). The bottom surface of the groove GR had low uniformity.

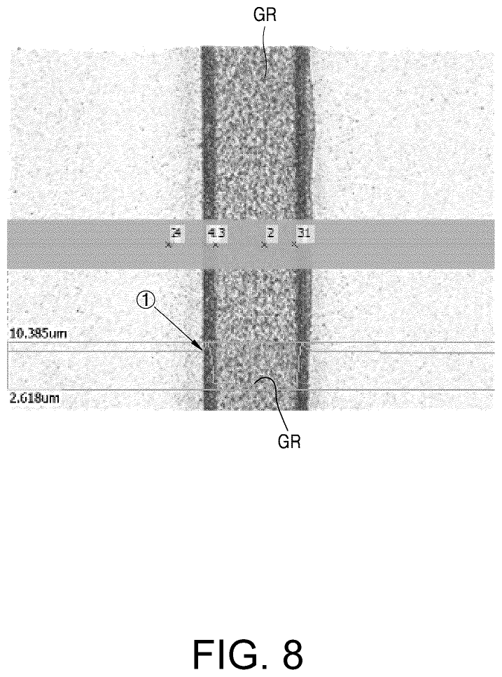

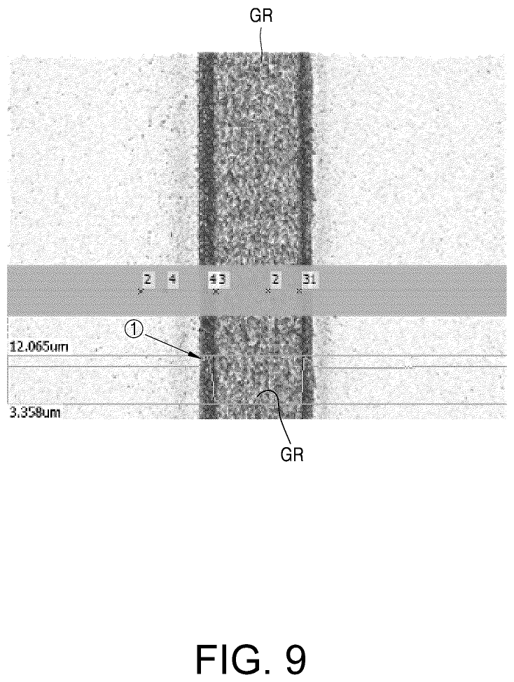

FIG. 8 is a diagram illustrating a groove processed with five sub-laser beams having a beam spacing of 150 μm. FIG. 9 is a diagram illustrating a groove processed with eight sub-laser beams having a beam spacing of 200 μm.

Referring to FIGS. 8 and 9, a planar photograph of the groove GR and a cross-sectional shape graph of the groove GR are illustrated in an overlapping manner. The groove GR had a small HAZ (\textcircled{1}) and did not have an over-processed lower area, unlike the grooves GR illustrated in FIGS. 6 and 7. The groove GR had an uniformly processed bottom surface.

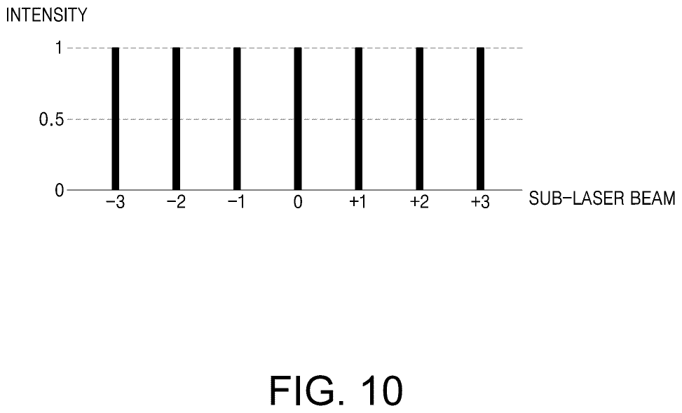

FIG. 10 is a graph showing relative intensities of sub-laser beams according to an exemplary embodiment.

Referring to FIG. 10, sub-laser beams SLB may have substantially the same intensity. The sub-laser beams SLB corresponding to the 0^{th} order, ±1^{st} order, ±2^{nd} order, and ±3^{rd} order diffraction beams illustrated in FIGS. 4 and 5 are respectively denoted by 0, ±1, ±2, and ±3. The absolute intensities of the sub-laser beams SLB may be determined as necessary. For example, the absolute intensities of the sub-laser beams SLB may be determined according to the type of the processing object 300 and/or the beam spacing between the sub-laser beams SLB.

Because the groove forming apparatuses 10 and 11 of the present disclosure form the groove GR with the sub-laser beams SLB having a beam spacing Db of 50 μm or more, the groove GR may be formed to have a required shape (for example, a shape in which the HAZ generation is minimized, the bottom surface of the groove GR is processed uniformed without excessive, and the lowermost width of the groove is 75% or more of the uppermost width of the groove).

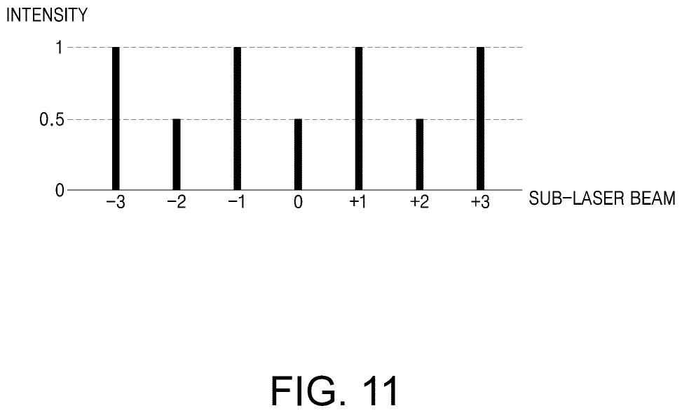

FIG. 11 is a graph showing relative intensities of sub-laser beams according to an exemplary embodiment.

Referring to FIG. 11, sub-laser beams SLB may have different intensities. The sub-laser beams SLB corresponding to the 0^{th} order, ±1^{st} order, ±2^{nd} order, and ±3^{rd} order diffraction beams illustrated in FIGS. 4 and 5 are respectively denoted by 0, ±1, ±2, and ±3. The intensities of the sub-laser beams SLB corresponding to the 0^{th} order and ±2^{nd} order diffraction beams may be half of the intensities of the sub-laser beams SLB corresponding to the ±1^{st} order and ±3^{rd} order diffraction beams. However, the relative intensities of the sub-laser beams SLB are not limited to the illustrated intensities and may be determined as necessary. The absolute intensities of the sub-laser beams SLB may be determined as necessary. For example, the absolute intensities of the sub-laser beams SLB may be determined according to the type of the processing object 300 and/or the beam spacing between the sub-laser beams SLB.

Because the groove forming apparatuses 10 and 11 of the present disclosure form the groove GR with the sub-laser beams SLB having a beam spacing Db of 50 μm or more, the groove GR may be formed to have a required shape (for example, a shape in which the HAZ generation is minimized, the bottom surface of the groove GR is processed uniformly without excessive, and the lowermost width of the groove is 75% or more of the uppermost width of the groove).

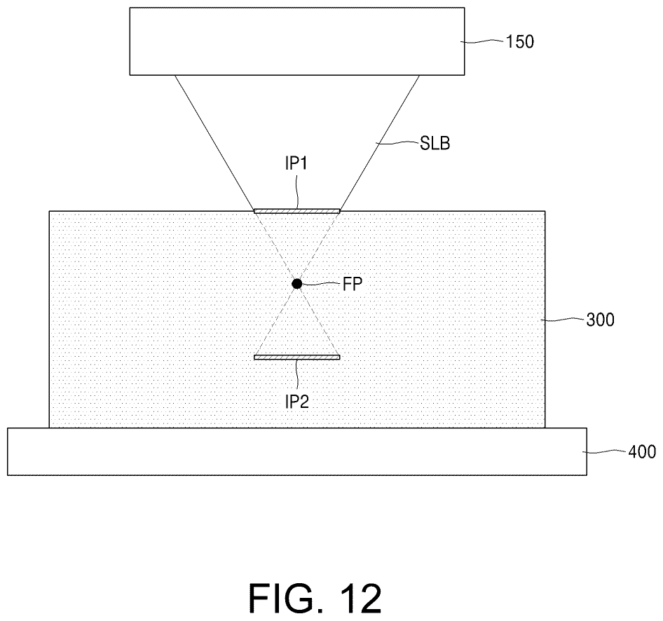

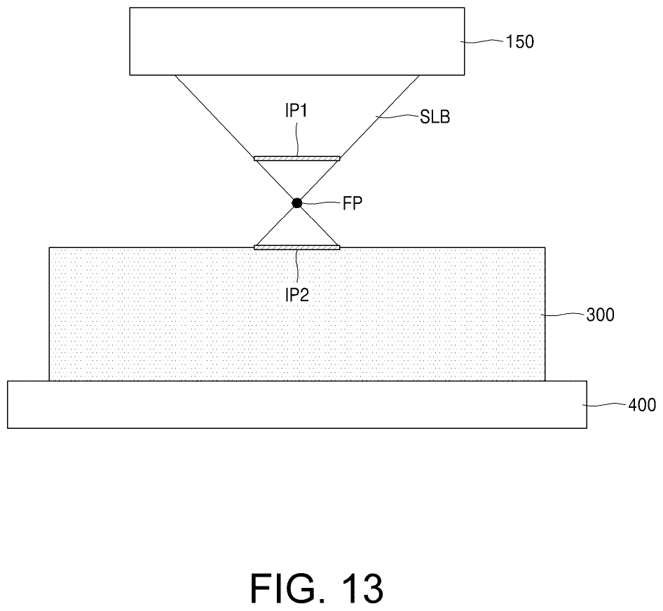

FIGS. 12 and 13 are conceptual diagrams for illustrating a positional relationship between the processing object and the focusing lens unit according to an exemplary embodiment.

For brevity of explanation, substantially the same content as that described with reference to FIGS. 1 and 2 and that described with reference to FIG. 3 may not be described.

Referring to FIGS. 12 and 13, the focusing lens unit 150 may focus sub-laser beams SLB on the processing object 300 arranged on the stage 400. The focusing lens unit 150 may have a first image plane IP1 located between the focal point FP and the focusing lens unit 150, and a second image plane IP2 located opposite the first image plane IP1 with respect to the focal point FP.

As illustrated in FIG. 12, the focusing lens unit 150 may be arranged so that the focal point of the focusing lens unit 150 is located inside the processing object 300. For example, the focusing lens unit 150 may be arranged so that the first image plane IP1 is located on the surface of the processing object 300. In this case, the processing object 300 may be processed by the sub-laser beams SLB of the first image plane IP1.

As illustrated in FIG. 13, the focusing lens unit 150 may be arranged so that the focal point of the focusing lens unit 150 is located between the processing object 300 and the focusing lens unit 150. For example, the focusing lens unit 150 may be arranged so that the second image plane IP2 is located on the surface of the processing object 300. In this case, the processing object 300 may be processed by the sub-laser beams SLB of the second image plane IP2.

The position of the focusing lens unit 150 may be determined as necessary.

The sidewall of the groove formed by the sub-laser beams SLB of the first image plane IP1 may be more inclined than the sidewall of the groove formed by the sub-laser beams SLB of the second image plane IP2. A certain image plane of the sub-laser beams SLB to form the groove may be determined according to the required groove shape.

Because the groove forming apparatuses 10 and 11 of the present disclosure form the groove GR with the sub-laser beams SLB having a beam spacing Db of 50 μm or more, the groove GR may be formed to have a required shape (for example, a shape in which the HAZ generation is minimized, the bottom surface of the groove GR is processed uniformly without excessive, and the lowermost width of the groove is 75% or more of the uppermost width of the groove).

The above description of the embodiments of the technical idea of the present disclosure provides examples for the description of the technical idea of the present disclosure. Therefore, the technical idea of the present disclosure is not limited to the embodiments described above, and within the technical idea of the present invention, it is apparent that various modifications and changes may be made thereof by combining the above embodiments by those of ordinary skill in the art.

What is claimed is:

1. A groove forming apparatus comprising:
a laser light source configured to emit a laser beam;
a multi-beam generator configured to split the laser beam into a plurality of sub-laser beams;
a focusing lens unit configured to focus the plurality of sub-laser beams on a processing object;
a first telecentric lens provided between the multi-beam generator and the focusing lens unit; and
a second telecentric lens provided between the first telecentric lens and the focusing lens unit.

2. The groove forming apparatus of claim 1, wherein a rear focal plane of the first telecentric lens and a front focal plane of the second telecentric lens overlap each other.

3. The groove forming apparatus of claim 1, wherein the first telecentric lens has a size to receive the plurality of sub-laser beams split at a maximum angle from the multi-beam generator.

4. The groove forming apparatus of claim 3, wherein the maximum angle is ±3°.

5. The groove forming apparatus of claim 1, wherein the multi-beam generator is configured to split the plurality of sub-laser beams so that a spacing between the plurality of sub-laser beams on the processing object is 50 μm or more.

6. The groove forming apparatus of claim 1, wherein spacings between the plurality of sub-laser beams on the processing object are equal to each other.

7. The groove forming apparatus of claim 1, wherein at least two of spacings between the plurality of sub-laser beams on the processing object are different from each other.

8. The groove forming apparatus of claim 1, wherein the plurality of sub-laser beams are symmetrically arranged on the processing object.

9. The groove forming apparatus of claim 1, wherein the plurality of sub-laser beams have same intensity.

10. The groove forming apparatus of claim 1, wherein at least two of the plurality of sub-laser beams have different intensities.

11. The groove forming apparatus of claim 1, further comprising a scan head,
wherein the focusing lens unit is arranged inside the scan head, and
the multi-beam generator, the first telecentric lens, and the second telecentric lens are arranged outside the scan head.

12. The groove forming apparatus of claim 1, further comprising a stage supporting the processing object,
wherein the stage is configured to adjust a position at which the plurality of sub-laser beams are focused on the processing object.

13. A groove forming apparatus comprising:
a laser light source configured to emit a laser beam;
a multi-beam generator configured to split the laser beam into a plurality of sub-laser beams; and
a focusing lens unit configured to focus the plurality of sub-laser beams on a processing object,
wherein the focusing lens unit is apart from the multi-beam generator so as to receive the plurality of sub-laser beams split at a maximum angle from the multi-beam generator.

14. The groove forming apparatus of claim 13, wherein the maximum angle is ±3°.

15. The groove forming apparatus of claim 13, wherein the multi-beam generator is configured to split the plurality of sub-laser beams so that a spacing between the plurality of sub-laser beams on the processing object is 50 μm or more.
